(19) United States
(12) Patent Application Publication
(10) Pub. No.: US 2009/0229643 A1
(43) Pub. Date: Sep. 17, 2009

(54) LEG SUPPORTING CRUTCH SYSTEM AND METHOD

(76) Inventors: Sharalyn S. Ramm, Lynnwood, WA (US); Joel N. Smith, Edmonds, WA (US); Jacqueline Cardinali, Seattle, WA (US)

Correspondence Address: AXIOS LAW GROUP. PLLC, 1525 4TH AVE, STE 800, SEATTLE, WA, 98101-1648, US

(21) Appl. No.: 12/047,268

(22) Filed: Mar. 12, 2008

(51) Int. Cl. A61H 3/02

(52) U.S. Cl. 135/69; 135/68

(57) ABSTRACT

Systems and methods are provided herein that provide for a leg supporting crutch.

### FIELD

This invention relates generally to assisted mobility, and more specifically, to systems and methods for providing a leg supporting crutch.

### BACKGROUND

Leg injuries are not a new issue for humans, and ancient artwork suggests that crutches may have provided a solution even as early as 5000 years ago. Since then, crutches have progressed from primitive structures such as T-shaped sticks to sophisticated lightweight ergonomic tools.

Several major classes of crutches exist today, which include, underarm, forearm, platform, and knee support crutches. Underarm or axillary crutches are most common in the United States and are typically used by persons having a temporary disability or injury. These crutches have a pad that rests in the armpits and against the rib cage, and a grip along the length of the crutch that allows a user to grasp the crutch for stabilization. Underarm crutches are used temporarily because they tend to be uncomfortable and cumbersome for users. The discomfort caused by the pad under a user's arm, the strength required to hold the handles, and lack of hands-free operation makes this type of crutch less than ideal.

Forearm crutches are more popular in Europe and for users with long term injury or disability. These crutches typically include a cuff that surrounds the forearm of a user and a handle that is perpendicular to an elongated portion of the crutch. Here, users grasp the handle of the crutch place their forearm in the cuff, which serves to support the user's weight. While forearm crutches are a marked improvement over underarm crutches, they are nonetheless cumbersome and may not be operated without the use of hands.

Similarly, platform crutches have a support for the forearm of a user and a handle, but these crutches allow users to hold their arms in a position perpendicular to their body while using the crutch. As with forearm crutches, platform crutches are cumbersome and require a user to grasp a handle, which does not provide hands-free operation of these crutches.

Knee support crutches are similar to forearm and underarm crutches, but provide a support for the bent knee of a user. Although this type of crutch allows a user to use both legs while walking and removes weight from an injured or disabled leg, knee support crutches typically require one or both hands for proper operation and control.

### BRIEF DESCRIPTION OF THE DRAWINGS

The present invention will be described by way of exemplary embodiments but not limitations, illustrated in the accompanying drawings in which like references denote similar elements, and in which:

FIG. 1 is an environmental view of a leg supporting crutch being used by a user, in accordance with various embodiments.

FIG. 2 is a rear view of a leg supporting crutch in accordance with various embodiments.

FIG. 3 is a front view of a leg supporting crutch in accordance with various embodiments.

FIG. 4 is a cross sectional view of a leg supporting crutch in accordance with various embodiments.

FIG. 5 is a side view of a leg supporting crutch in accordance with various embodiments.

FIG. 6 is a close-up perspective view of a leg supporting crutch in accordance with various embodiments.

FIG. 7 is a side view of a leg supporting crutch in accordance with various embodiments.

### DESCRIPTION

Illustrative embodiments presented herein include, but are not limited to, systems and methods for providing a leg supporting crutch.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations will be described as multiple discrete operations, in turn, in a manner that is most helpful in understanding the embodiments described herein; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

The following Figures depict exemplary systems and methods for providing a leg supporting crutch. In various embodiments described and shown, there may be a leg supporting crutch that includes a supporting member configured to support a user's bent knee and a stabilizing member coupled to the supporting member. In some embodiments the stabilizing member comprises a bent stabilizing bar and a handle. In other embodiments, the stabilizing member and supporting member are adjustable.

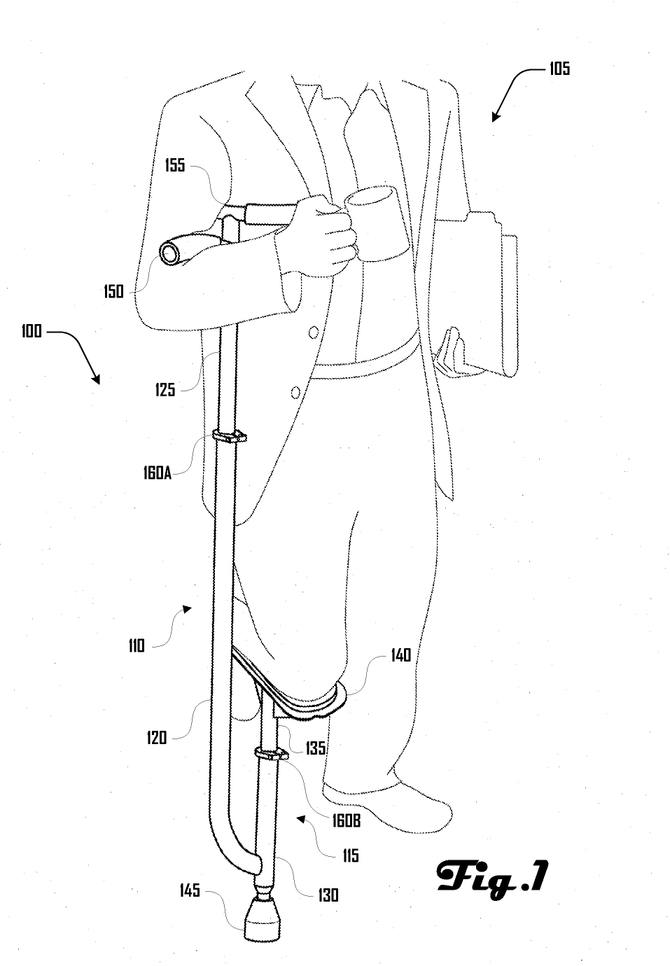

FIG. 1 is an environmental view of a leg supporting crutch 100 being used by a user 105, in accordance with various embodiments. The leg supporting crutch 100 comprises a supporting member 115 and a stabilizing member 110.

In the embodiment depicted in FIG. 1, the supporting member 115 comprises an elongated first supporting body 130, and an elongated second supporting body 135, which are coupled via a clamp 160B The first supporting body 130 comprises a tip 145 and the second supporting body 135 further comprises a leg support 140.

In the embodiment depicted in FIG. 1, the stabilizing member 110 comprises a first stabilizing body 120 and a second stabilizing body 125, which are coupled via a clamp 160A. The first stabilizing body 120 is coupled to the supporting member 115. The second stabilizing body 125 further comprises a handle 150 and a stabilizing bar 155.

As depicted here, a user 105 may support the user's 105 bent knee on the leg support 140 and wrap the user's arm 105 around the stabilizing member 110 such that the user's 105 arm is under the handle 150 and the stabilizing bar 155 is positioned about the user's 105 torso. In such an embodiment, the user 105 may stabilize the leg supporting crutch 100 without the use of the user's 105 hands, which is illustrated here by the user 105 freely holding a coffee cup and a file folder. As a user 105 walks with the leg supporting crutch 100, the leg supporting crutch 100 may be held in position by the user's 105 elbow and arm along with friction between the user's 105 torso and the stabilizing bar 155.

In another embodiment, a the leg supporting crutch 100 can be configured such that the stabilizing bar 155 can be held along various lengths of a user's 105 body, which can include the upper and lower torso, waist, leg, or the like. In a further embodiment, a user 105 can grasp the handle 150 with the user's 105 hand. In a further embodiment, a user 105 can grasp the stabilizing member 110.

The leg supporting crutch 100 may be configured to a user 105 of various shapes and sizes. For example, the first and second stabilizing body 120, 125 may be slidably and/or rotationally configurable such that the stabilizing member 110 may be adjusted by length and rotation. Similarly, the first and second supporting body 135, 130 may be slidably and/or rotationally configurable such that the supporting member 115 may be adjusted by length and rotation. Desired configurations of the leg supporting crutch 100 may be achieved by tightening one or more clamp 160A, 160B, such that configurable members are locked in a given configuration.

In one embodiment, the leg supporting crutch 100 may be configured to support an amputee user 105 or a user 105 having leg deformation. For example, the leg support 140 and associated structures may be configured to support a user 105 having a leg amputation or deformation of or about the tibia, fibula, femur, knee, or the like. In another embodiment, the leg supporting crutch 100 may be configured to allow a user 105 with other deformations or amputations to use the leg supporting crutch 100, which may include modification of the stabilizing bar 155, handle 150, and the like.

In various embodiments, a user 105 may support a bent knee in the leg support 140 while walking with the leg supporting crutch 100. This may be desirable in some embodiments because force that would normally be applied to the leg of a user 105 while walking would instead be directed to the bent knee of a user 105 while walking with the assistance of the leg supporting crutch 100. Accordingly, in one example, a user 105 having an injury below the knee would be able to walk with a relatively normal gait without applying pressure or strain to the below-knee injury.

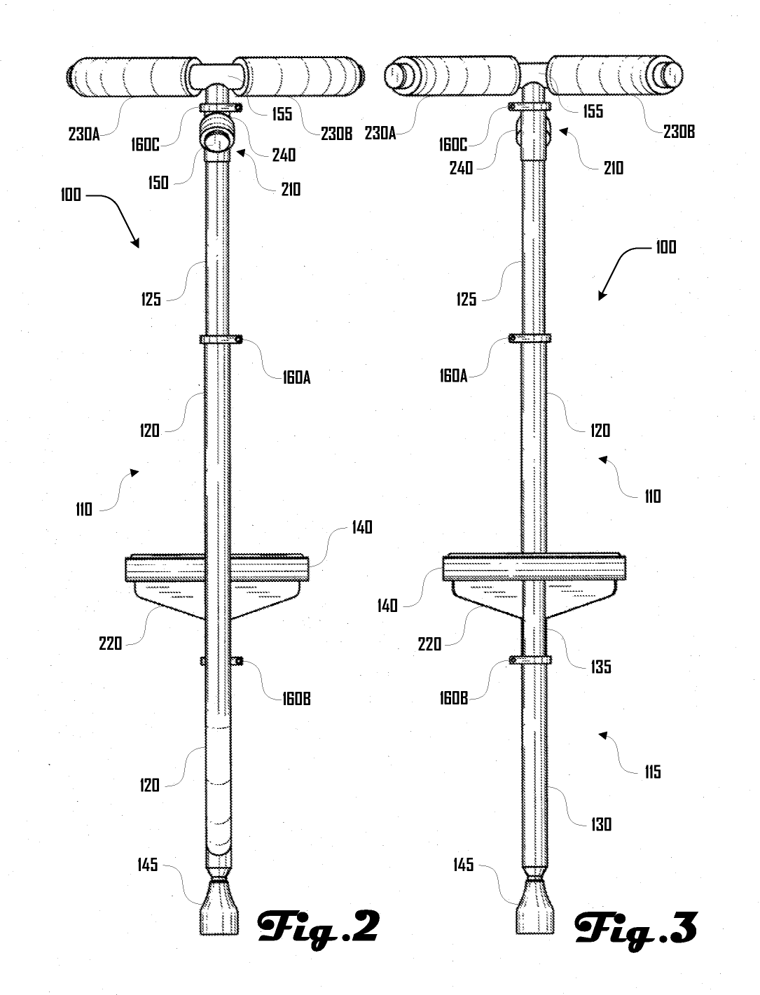

FIG. 2 is a rear view of a leg supporting crutch 100 in accordance with various embodiments, and FIG. 3 is a front view of a leg supporting crutch 100 in accordance with various embodiments. As shown in the exemplary embodiment of FIGS. 2 and 3, the leg supporting crutch 100 comprises a stabilizing member 110 and a supporting member 115.

The supporting member 115 further comprises a first supporting body 130 and a second supporting body 135. In the embodiment depicted in FIGS. 2 and 3, the first supporting body 130 is an elongated body that comprises a tip 145 at a terminal end of the supporting body 130. The tip 145, in some embodiments, may be an elastic structure that frictionally engages a surface that a user 105 is walking on. For example, the tip 145 may comprise materials such as rubber, plastic, latex, or the like. In various embodiments, the tip 145 may be absent.

The second supporting body 135 is an elongated body comprising a leg support 140 at an upper end, and leg support wings 220, which may provide support for the leg support 140 in relation to the second supporting body 135. In one embodiment, the leg support wings 220 may be absent.

As depicted in FIGS. 2 and 3, the stabilizing member 110 comprises a first stabilizing body 120, a second stabilizing body 125, and a third stabilizing body 210. The first stabilizing body 120 is coupled to the supporting member 115 and is coupled to the second stabilizing body 125.

The second stabilizing body 125 comprises a stabilizing bar 155, which is covered by a bar pad 230A, 230B on each end of the stabilizing bar 155. In the embodiment shown in FIGS. 2 and 3, the stabilizing bar 155 may be a bent or curved, which may correspond to the torso of a user 105. In another embodiment, the stabilizing bar 155 may be roughly linear, or may be various irregular shapes. As depicted here, the stabilizing bar 155 is an elongated bar that is roughly perpendicular to the first stabilizing body 120; however, in a further embodiment, the stabilizing bar 155 may be at various angles, and need not comprise a first and second end that are both roughly perpendicular to the first stabilizing body 120. For example, in one embodiment, the stabilizing bar 155 may be coupled to the first stabilizing body 120 at a first end and extend to a second end. In a still further embodiment the one or more bar pad 230A, 203B may be absent or the stabilizing bar 155 may be absent.

The third stabilizing body 210 comprises a handle 150, which is covered by a handle pad 240. As depicted in the exemplary embodiment of FIGS. 2 and 3, the third stabilizing body 210 may be a member that resides around the first stabilizing body 120 and is slidably and rotatably configurable about the first stabilizing body 120. Additionally, the third stabilizing body 210 may be held or fixed in various configurations via a clamp 160C. For example, in various embodiments, changing the configuration of the third stabilizing body 210 may allow a user 105 to change the height of the handle 150 in relation to the body of the user 105. In one embodiment, the handle pad 240 may be absent.

As depicted in FIG. 3, the handle 150 is positioned roughly perpendicular to the stabilizing bar 155 and positioned roughly perpendicular to the stabilizing member 110. In another embodiment, the handle 150 can be roughly parallel to the stabilizing bar 155 and/or positioned roughly parallel to the stabilizing member 110. In a still further embodiment, the handle 150 can be positioned at various angles in relation to the stabilizing bar 155 and stabilizing member 110.

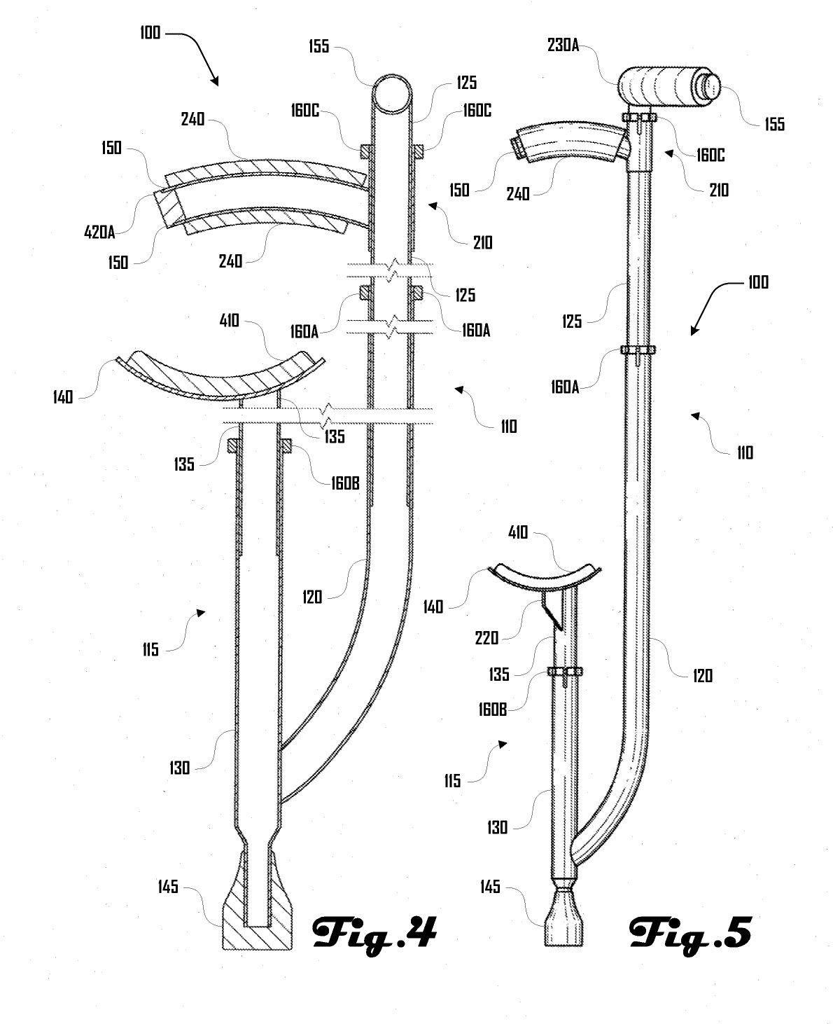

FIG. 4 is a cross sectional view of an exemplary embodiment of a leg supporting crutch 100 in accordance with various embodiments. The leg supporting crutch 100 comprises a stabilizing member 110, and a supporting member 115.

The supporting member 115 comprises a first supporting body 130 and a second supporting body 135 and the second supporting body 135 resides within the first supporting body 130. For example, in one embodiment, the first and second supporting body 130, 135 comprise elongated hollow tubes and the radius of the second supporting body 135 is such that the second supporting body 135 may reside within the diameter of the first supporting body 130. Additionally, the length of the supporting member 115 may be changed by slidably configuring the first and second support body 130, 135, and various length configurations of the supporting member 115 may be fixed or held via a clamp 160B.

The clamp 160B may be positioned at a top end of the first support body 130 and may be configurable to constrict the diameter of first support body 130 such that friction generated between the first and second support body 130, 135 allows the first and second support body 130, 135 to be held or fixed in a desired configuration. Although a clamp 160A, 160B, 160C is illustrated and described as being part of various embodiments, one of ordinary skill in the art would immediately appreciate that various structures may be employed to allow elongated members to be slidably configurable. For example, various clamps, slots and pins, springs, adhesives, bolts, and a multitude of other structures may be employed that are within the scope of various embodiments.

Returning to FIG. 4, the second supporting body 135 comprises a leg support 140 that includes a support pad 410. As shown in FIG. 4, the leg support 140 may be a curved structure that houses the support pad 410, which may be configured to support the leg, knee, or other part of a lower limb of a user 105. One of ordinary skill in the art will appreciate the various configurations of the leg support 140 and leg pad 410 that are within the scope of various embodiments.

The stabilizing member 110 comprises a first stabilizing body 120, a second stabilizing body 125, and a third stabilizing body 210. The first stabilizing body 120 may be coupled to the first supporting body 130 along the length of the first supporting body 130. Coupling the first supporting body 130 and the first stabilizing body 120 may be achieved via various methods including welding, an adhesive, a clamp, slot and pin, and the like. In one embodiment the first supporting body 130 may be coupled to the first stabilizing body 120 along a length of the first stabilizing body 120. In a further embodiment, the first stabilizing body 120 may include a tip 145.

In various embodiments depicted herein, the stabilizing member 110 is an elongated structure that curved at a bottom end and is coupled to the support member 115 along a length of the support member 115. Both the stabilizing member 110 and support member 115 may be tube structures, and the end of the stabilizing member 110 may be coupled to the support member 115 such that the stabilizing member 110 and support member 115 are roughly perpendicular where the stabilizing member 110 and support member 115 are coupled. The stabilizing member 110 can curve or bend such that a length of the stabilizing member 110 is roughly parallel to the support member 115.

However, it should be clear to one of ordinary skill in the art, that stabilizing member 110 and support member 115 can be coupled in various ways and be configured in various orientations in relation to each other. For example, the stabilizing member 110 and support member 115 may be parallel to each other along a length where the stabilizing member 110 and support member 115 are coupled. Additionally, the angle between the stabilizing member 110 and support member 115 may be variable, configurable, or different in various embodiments.

As shown here in FIG. 4, the second stabilizing body 125 resides within the first stabilizing body 120. For example, the first and second stabilizing body 120, 125 may be elongated hollow tube structures with radius and diameter such that the second stabilizing body 125 may reside within the first stabilizing body 120. The first and second stabilizing body 120, 125 may be slidably configurable such that the length of the stabilizing member 110 may be changed. Various configurations of the first and second stabilizing body 120, 125 may be fixed or secured via a clamp 160A that may be positioned at a top end of the first stabilizing body 120, and the clamp 160A may be configured so that the diameter of the first stabilizing body 120 is constructed such that friction created between the first and second stabilizing body 120, 125 fixes or secures a desired configuration of the first and second stabilizing body 120, 125.

Similarly the third stabilizing body 210 may have a diameter that roughly corresponds to the first stabilizing body 120 or that is configured such that the third stabilizing body 210 may surround the second stabilizing body 125. For example, the third stabilizing body 210 may be slidably configurable along a length of the second stabilizing body 125 and may be secured in a given configuration by a clamp 160C that constricts the third stabilizing body 210 such that the third stabilizing body 210 is held, fixed or coupled about the second stabilizing body 125.

The third stabilizing body 210, as depicted in FIG. 4, may comprise a handle 150, and the handle 150 may be covered by handle pad 240. Additionally, where the handle 150 is a hollow elongated structure, a distal end of the handle 150 may comprise and be covered and/or filled by a plug 420A.

Although various embodiments depicted herein include a leg supporting crutch 100 comprising hollow tubular members and bodies, it should be clear to one of ordinary skill in the art that architecture and structures of a leg supporting crutch 100 may comprise various shapes and materials that are within the scope of various embodiments. For example a leg supporting crutch 100 may comprise solid extended members, wires, and the like. Additionally, a supporting leg crutch 100 may comprise various materials, including aluminum, iron, steel, plastic, composite material, fiberglass, wood, combinations thereof, and the like.

Additionally, in various embodiments, a leg supporting crutch 100 may have various supporting member 115 and stabilizing member 110 configurations. For example, in one embodiment, the supporting member 115 and/or the stabilizing member 110 may be a single structure that may not change in length. Additionally, in a further embodiment, there may be one or more supporting member 115 and/or the stabilizing member 110. In a further embodiment, there may be one or more stabilizing body 120, 125, 210 and/or one or more supporting body 130, 135.

In other embodiments, a stabilizing body 120, 125, 210 and/or one or more supporting body 130, 135 may be in various configurations. For example, in one embodiment, the diameter of the first supporting body 130 may be such that the first supporting body 130 resides within the second supporting body 135. In another embodiment, the first stabilizing body 120 may be configured such that the first stabilizing body 120 resides within the second stabilizing body 125. In a further embodiment, the first and/or second stabilizing body 120, 125 may comprise a handle 150 and/or a stabilizing bar 155. In a further embodiment, the second stabilizing body 125 may be configured such that the second stabilizing body 125 resides within the third stabilizing body 210, and the third stabilizing body 210 may be configured such that the third stabilizing body 210 resides within the first stabilizing body 120.

In a still further embodiment, the third stabilizing body 210 may reside within one or both of the first and second stabilizing body 120, 125. Also, in another embodiment, the handle 150 and or the stabilizing bar 155 may extend through an orifice defined by one or both of the first and second stabilizing body 120, 125.

In one embodiment, the supporting member 115 can be absent, and a leg support 140 and/or support pad 410 can be coupled to the stabilizing member 110. For example, there can be rods, bars, or other supports that extend from the stabilizing member 110 that couple a leg support 140 and/or support pad 410 to the stabilizing member. Additionally, a leg support 140 and/or support pad 410 can be directly coupled to the stabilizing member, e.g., with a lateral tube (as shown) movably affixed to the stabilizing member.

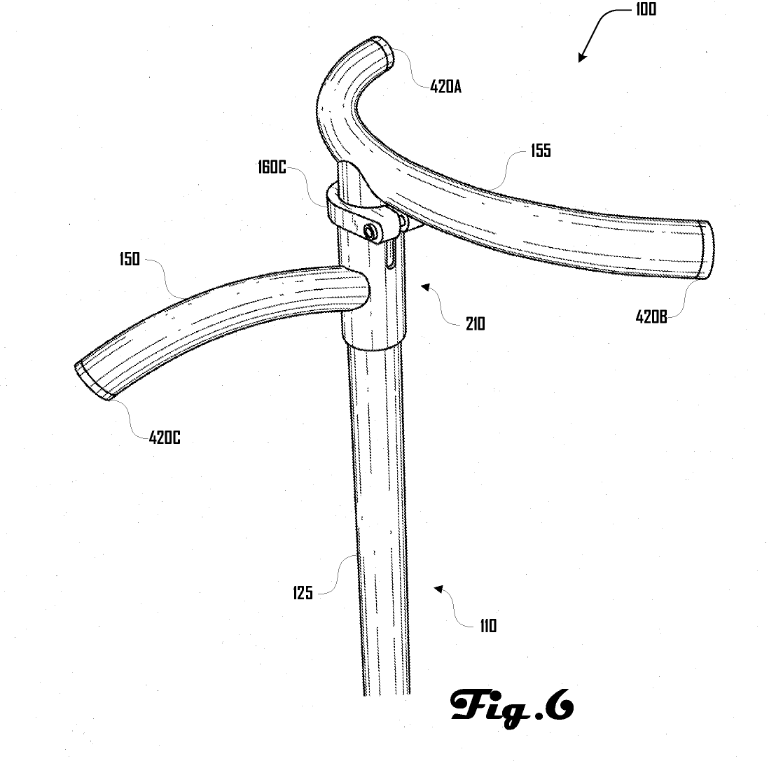

FIG. 5 is a side view of a leg supporting crutch 100 in accordance with various embodiments, which comprises a supporting member 115 and a stabilization member 110. The supporting member 115 comprises a first supporting body 130 and a second supporting body 135 and the second supporting body 135 resides within the first supporting body 130. As depicted in FIG. 5, the first and second supporting body 130, 135 comprise elongated hollow tubes and the radius of the second supporting body 135 is such that the second supporting body 135 may reside within the diameter of the first supporting body 130. Additionally, the length of the supporting member 115 may be changed by slidably configuring the first and second support body 130, 135, and various length configurations of the supporting member 115 may be fixed or held via a clamp 160B.

The clamp 160B may be positioned at a top end of the first support body 130 and may be configurable to constrict the diameter of first support body 130 such that friction generated between the first and second support body 130, 135 allows the first and second support body 130, 135 to be held or fixed in a desired configuration. Although a clamp 160A, 160B, 160C is illustrated and described as being part of various embodiments, one of ordinary skill in the art would immediately appreciate that various structures may be employed to allow elongated members to be slidably configurable. For example, various clamps, slots and pins, springs, adhesives, bolts, and a multitude of other structures may be employed that are within the scope of various embodiments.

In one embodiment, a supporting body 130, 135 or stabilizing body 120, 125, 210 may comprise a notch around which the supporting body 130, 135 or stabilizing body 120, 125, 210 is coupled via a clamp 160A, 160B, 160C. In various embodiments, it may be desirable to for a supporting body 130, 135 or stabilizing body 120, 125, 210 to comprise a notch because the notch may allow more efficient constriction of a supporting body 130, 135 or stabilizing body 120, 125, 210 such that various configurations and or lengths can be secured by a clamp 160A, 160B, 160C or other securing or coupling structure.

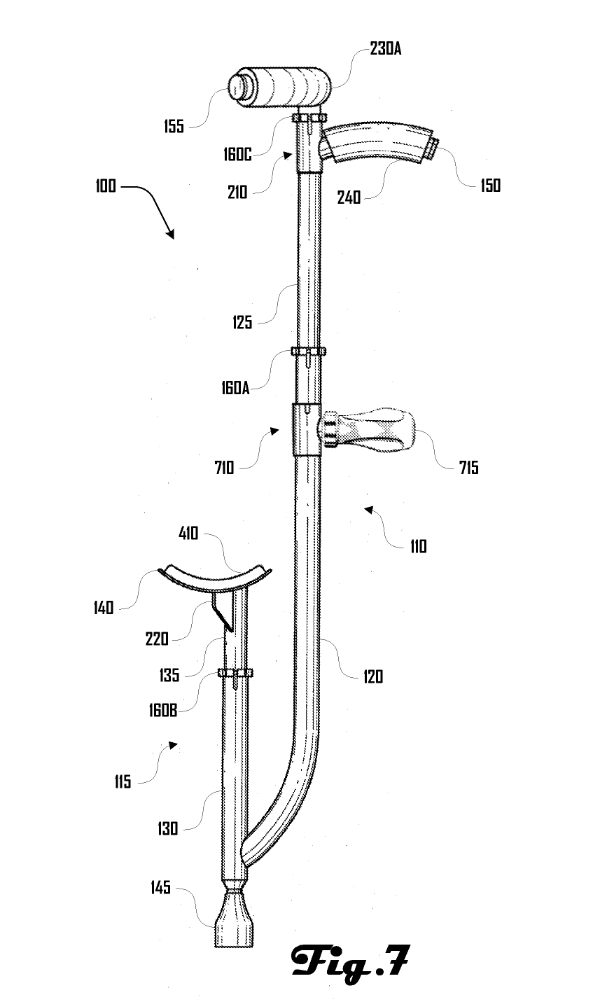

FIG. 6 is a close-up perspective view of a leg supporting crutch 100 in accordance with various embodiments. Depicted in FIG. 6 is a stabilizing member 110 that comprises a second stabilizing body 125 and a third stabilizing body 210. The second stabilizing body 125 comprises a stabilizing bar 155 that is an elongated curved bar that includes plugs 420A, 420B at the distal ends of the stabilizing bar 155. The third stabilizing body 210 comprises a handle 150 that is an elongated curved tube with a plug 420C at a distal end of the handle 150. The third stabilizing body 210 encompasses a length of the second stabilizing body 125 and may be held in place or in a given configuration via a clamp 160C that is located at a top end of the third stabilizing body 210. In one embodiment, the clamp 160C may be located in various positions along the length of the third stabilizing body 210.

As discussed herein, FIG. 6 depicts an exemplary embodiment of a leg supporting crutch 100 comprising a second and third stabilizing body 125, 210; however, in some embodiments, the handle 150 may be coupled to the second supporting body 135 or the second and third supporting body 125, 210 may be coupled within each other in various configurations.

FIG. 7 is a side view of a leg supporting crutch 100 in accordance with various embodiments, which comprises a supporting member 115 and a stabilization member 110. The supporting member 115 comprises a first supporting body 130 and a second supporting body 135 and the second supporting body 135 resides within the first supporting body 130. As depicted in FIG. 7, the first and second supporting body 130, 135 comprise elongated hollow tubes and the radius of the second supporting body 135 is such that the second supporting body 135 may reside within the diameter of the first supporting body 130. Additionally, the length of the supporting member 115 may be changed by slidably configuring the first and second support body 130, 135, and various length configurations of the supporting member 115 may be fixed or held via a clamp 160B.

Returning to FIG. 7, the second supporting body 135 comprises a leg support 140 that includes a support pad 410. As shown in FIG. 4, the leg support 140 may be a curved structure that houses the support pad 410, which may be configured to support the leg, knee, or other part of a lower limb of a user 105. One of ordinary skill in the art will appreciate the various configurations of the leg support 140 and leg pad 410 that are within the scope of various embodiments.

The stabilizing member 110 comprises a first stabilizing body 120, a second stabilizing body 125, a third stabilizing body 210 and a fourth stabilizing body 710. The first stabilizing body 120 may be coupled to the first supporting body 130 along the length of the first supporting body 130.

As shown here in FIG. 7, the second stabilizing body 125 resides within the first stabilizing body 120. For example, the first and second stabilizing body 120, 125 may be elongated hollow tube structures with radius and diameter such that the second stabilizing body 125 may reside within the first stabilizing body 120. The first and second stabilizing body 120, 125 may be slidably configurable such that the length of the stabilizing member 110 may be changed. Various configurations of the first and second stabilizing body 120, 125 may be fixed or secured via a clamp 160A that may be positioned at a top end of the first stabilizing body 120, and the clamp 160A may be configured so that the diameter of the first stabilizing body 120 is constructed such that friction created between the first and second stabilizing body 120, 125 fixes or secures a desired configuration of the first and second stabilizing body 120, 125.

Similarly the third stabilizing body 210 may have a diameter that roughly corresponds to the first stabilizing body 120 or that is configured such that the third stabilizing body 210 may surround the second stabilizing body 125. For example, the third stabilizing body 210 may be slidably configurable along a length of the second stabilizing body 125 and may be secured in a given configuration by a clamp 160C that constricts the third stabilizing body 210 such that the third stabilizing body 210 is held, fixed or coupled about the second stabilizing body 125.

The third stabilizing body 210, as depicted in FIG. 7, may comprise a handle 150, and the handle 150 may be covered by handle pad 240. Additionally, where the handle 150 is a hollow elongated structure, a distal end of the handle 150 may comprise and be covered and/or filled by a plug 420A.

As depicted in FIG. 7, the fourth stabilizing body 710 may comprise a grip 715 (e.g. a hollow tubular body, or the like). The fourth stabilizing body 710 may surround the first stabilizing body 120 and may be slidably configurable along the length of the first stabilizing body 120. In one embodiment, the fourth stabilizing body 710 can be held or fixed in a given configuration in various ways, which can include various clamps, slots and pins, springs, adhesives, bolts, and a multitude of other structures may be employed.

Additionally, in various embodiments, a leg supporting crutch 100 may have various supporting member 115 and stabilizing member 110 configurations. For example, in one embodiment, the supporting member 115 and/or the stabilizing member 110 may be a single structure that may not change in length. Additionally, in a further embodiment, there can be one or more handle 150 or grip 715 on any of the first, second, third or fourth stabilizing body 120, 125, 210, 710. In a further embodiment, any of the first, second, third or fourth stabilizing body 120, 125, 210, 710 can be absent, and there can be one or more handle 150 or grip 715 located on various structures.

In other embodiments, a stabilizing body 120, 125, 210, 710 and/or one or more supporting body 130, 135 may be in various configurations. In another embodiment, the first stabilizing body 120 may be configured such that the first stabilizing body 120 resides within the second stabilizing body 125. In a further embodiment, the first and/or second stabilizing body 120, 125 may comprise a handle 150 and/or a stabilizing bar 155. In a further embodiment, the second stabilizing body 125 may be configured such that the second stabilizing body 125 resides within the third stabilizing body 210, and the third stabilizing body 210 may be configured such that the third stabilizing body 210 resides within the first stabilizing body 120. In yet another embodiment, any of the first, second, or third stabilizing body 120, 125, 210, can be configured to reside within the fourth stabilizing body 710.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes may be made without departing from the spirit and scope of the embodiments described herein.

1. A leg supporting crutch comprising:
a support member comprising a leg support at a first support member end, said support member coupled to a side of a stabilizing member, said stabilizing member comprising:
a stabilizing bar coupled near a top portion of said stabilizing member; and
a handle coupled near a top portion of said stabilizing member and extending therefrom.

2. The leg supporting crutch of claim 1, wherein said leg support comprises a pad.

3. The leg supporting crutch of claim 2, wherein said pad and said leg support are configured to support a knee of a user.

4. The leg supporting crutch of claim 2, wherein said pad and said leg support are configured to support a leg amputee user.

5. The leg supporting crutch of claim 2, wherein said stabilizing bar is bent.

6. The leg supporting crutch of claim 5, wherein said stabilizing bar comprises a bar pad.

7. The leg supporting crutch of claim 6, wherein said handle comprises a handle pad.

8. The leg supporting crutch of claim 1 wherein said supporting member is adjustable by length of said supporting member.

9. The leg supporting crutch of claim 8,
wherein said stabilizing member comprises a first and second slidable member configurable to slidabley adjust the length of said supporting member;
wherein said first slidable member comprises said first stabilizing member end; and
wherein said second slidable member comprises said stabilizing bar and said handle.

10. The leg supporting crutch of claim 9, wherein said second slidable member is configured to slidably reside within said first slidable member.

11. The leg supporting crutch of claim 10, wherein said first and second slidable member can be locked in a configuration.

12. The leg supporting crutch of claim 8,
wherein said stabilizing member comprises a first, second and third slidable member configurable to slidabley adjust the length of said supporting member;
wherein said first slidable member comprises said first stabilizing member end;
wherein said second slidable member comprises said handle; and
wherein said third slidable member comprises said stabilizing bar.

13. The leg supporting crutch of claim 12, wherein said third slidable member is configured to slidably reside within said first slidable member.

14. The leg supporting crutch of claim 13, wherein said first and third slidable member can be locked in a configuration.

15. The leg supporting crutch of claim 14, wherein said third slidable member is configured to slidably reside within said first and second slidable member.

16. The leg supporting crutch of claim 15, wherein said first second and third slidable member can be locked in a slidable configuration.

17. The leg supporting crutch of claim 16, wherein said support member further comprises a tip at a second end of said support member.

18. The leg supporting crutch of claim 17, wherein said locking is achieved via a clamp.

19. The leg supporting crutch of claim 18, wherein said locking is achieved via one or more clamp.

20. The leg supporting crutch of claim 19, wherein said first second and third slidable member are tubular.
